(19) United States
(12) Patent Application Publication
(10) Pub. No.: US 2004/0218095 A1
(43) Pub. Date: Nov. 4, 2004

(54) System, method, and apparatus for transmitting data with a graphics engine

(76) Inventors: Tuan Nguyen, San Jose, CA (US); Jason Herrick, Newark, CA (US)

Correspondence Address: MCANDREWS HELD & MALLOY, LTD, 500 WEST MADISON STREET, SUITE 3400, CHICAGO, IL, 60661

(21) Appl. No.: 10/819,736

(22) Filed: Apr. 7, 2004

Related U.S. Application Data
(60) Provisional application No. 60/466,374, filed on Apr. 29, 2003.

(51) Int. Cl. H04N 9/74; H04N 7/087

(52) U.S. Cl. 348/476; 348/478

(57) ABSTRACT

A system, method, and apparatus for transmitting data with a graphics engine are presented herein. The graphics engine encodes pixels in a frame with values that are a function of samples for a signal. The signal represents the transmitted data.

### RELATED APPLICATIONS

This application claims priority to Provisional Application for U.S. Patent Serial No. 60/466,374, entitled “System, Method, and Apparatus for VPS Encoding with Graphics Engine”, filed Apr. 29, 2003, by Nguyen, et. al., and the said application is incorporated herein by reference in its entirety for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Common video standards such as PAL and NTSC provide for the timing and display of video data. Video data comprises a series of video frames. Common video standards provide for a vertical synchronization pulse between video frames. The vertical synchronization pulse is an indicator that indicates a change of frame. The vertical synchronization pulse is followed by a time period known as the vertical blanking interval (VBI). The VBI is followed by another time period during which video data is displayed on a display device.

During the vertical blanking interval various control data can be communicated from the transmitting end to the display device. For example, this information can include control data, such as an indicator identifying the video as part of a particular program. The Video Programming System is a standard for providing control information and is incorporated herein by reference. The SID AMOL is another standard for providing control information and is also incorporated herein by reference. Additionally, the information can include data related to certain features such as Closed Captioning.

The foregoing information is commonly transmitted by a video encoder using hardware. Generally, the video encoder includes both a graphics engine for transmitting video data and specialized hardware for transmitting information during the vertical blanking interval. The hardware is generally hardwired.

As new standards for communicating information in the vertical blanking interval become available, a problem occurs for adapting preexisting integrated circuits that were not designed with the functionality conforming to the new standards. The preexisting integrated circuits are unlikely to include the specialized hardware for transmitting the information pursuant to newer standards.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

Presented herein are system(s), method(s), and apparatus for encoding data with a graphics engine.

In one embodiment, there is presented a method for transmitting data. The method includes determining one or more samples for a signal, the signal representing the data and generating a frame comprising at least one pixel that is a function of particular ones of the one or more samples.

In another embodiment, there is presented a video encoder for transmitting data. The video encoder comprises a graphics engine. The graphics engine determines one or more samples for a signal, the signal representing the data and generating a frame comprising at least one pixel that is a function of particular ones of the one or more samples.

In another embodiment, there is presented an integrated circuit for transmitting data. The integrated circuit includes a processor for executing a plurality of instructions and a memory. The memory stores a plurality of executable instructions. Execution of the plurality of executable instructions by the processor causes determining one or more samples for a signal, the signal representing the data, and generating a frame comprising at least one pixel that is a function of particular ones of the one or more samples.

These and other advantages and novel features of the embodiments in the present application will be more fully understood from the following description and in connection with the drawings.

### BRIEF DESCRIPTION OF SEVERAL VIEWS OF THE DRAWINGS

FIG. 1 is a block diagram describing an exemplary video encoder in accordance with an embodiment of the present invention;

FIG. 2 is a block diagram describing an exemplary VPS signal;

FIG. 3A is a block diagram of an exemplary PAL 625 Lines System frame;

FIG. 3B is a block diagram of samples corresponding to pixels for the exemplary VPS signal of FIG. 2;

FIG. 4 is a block diagram describing an exemplary video encoder in accordance with another embodiment of the present invention;

FIG. 5 is a block diagram describing an exemplary signal for the bit pattern “00000” and a signal for the bit pattern “11111”;

FIG. 6 is a block diagram of exemplary signals for “00000” in accordance with an embodiment of the present invention;

FIG. 7 is a block diagram of exemplary signal for “11111” in accordance with an embodiment of the present invention;

FIG. 8 is a block diagram describing the concatenation of signals in accordance with an embodiment of the present invention;

FIG. 9 is a block diagram of an exemplary video encoder in accordance with another embodiment of the present invention; and

FIG. 10 is a flow diagram describing encoding auxiliary data in accordance with an embodiment of the present invention.

### DETAILED DESCRIPTION OF THE INVENTION

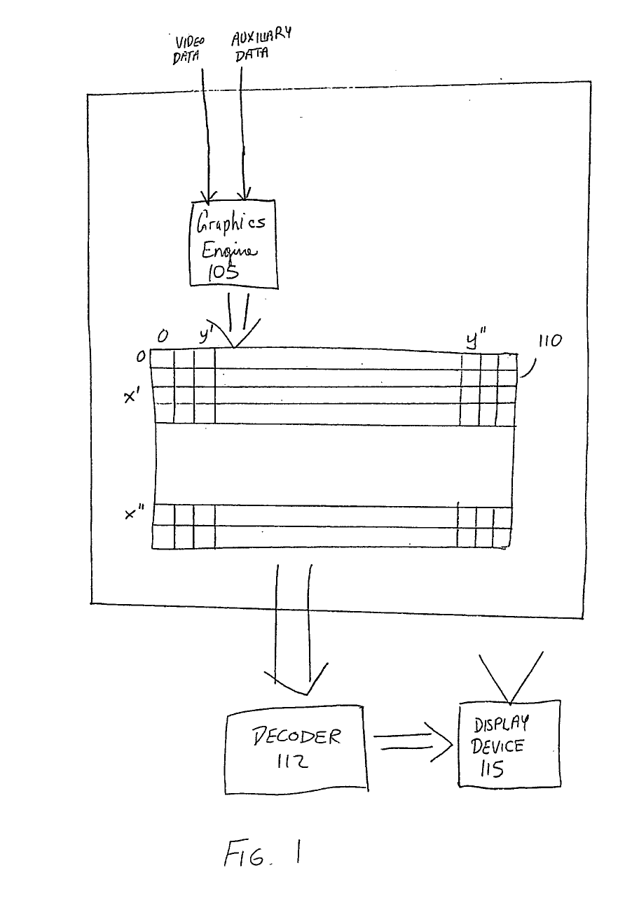

Referring now to FIG. 1, there is illustrated a block diagram describing an exemplary video encoder 100 in accordance with an embodiment of the present invention. The video encoder 100 comprises a graphics engine 105. The graphics engine 105 receives video data and auxiliary data, and outputs frames 110. The frames 110 comprise a two dimensional array of pixels 110(x,y). A portion of each frame 110 , pixels 110(x′-x″,y′-y″) corresponds directly to the video data (now referred to as the video portion of the frame). Another portion of the frame 110, pixels 110 (0-(x′-1), 0-(y′-1)) carries the auxiliary data.

The frames 110 are transmitted for display on a display device 115. The frames 110 are received by a decoder 112. The decoder 112 transforms the pixels from the frames 110 into an analog signal. The analog signal causes the display device 115 to display the video data and recover the auxiliary data. The display of a particular frame 110 is synchronized by a signal known as a vertical synchronization pulse. During the display of the frames 110, the pixels 110(x,y) are scanned and converted as samples into an analog signal received by the display device in either interlaced order of progressive order. In an interlaced scan, each even-numbered line 0, 2, 4, . . . , from top to bottom is scanned from left to right, followed by each odd-numbered line. In progressive scanning, each line from top to bottom is scanned from left to right.

The time period immediately after the vertical synchronization pulse is known as the vertical blanking interval (VBI). During the vertical blanking interval, pixels 110(0-(x′-1), 0-(y′-1)) that carry the auxiliary data are scanned. Although the pixels 110(0-(x′-1), 0-(y′-1)) are scanned, the pixels are not displayed. The scanning of the pixels 110(0-(x′-1), 0-(y′-1)) carrying the auxiliary data causes the generation of an analog signal. The display device 115 recovers the auxiliary data from the analog signal generated from the pixels 110(0-(x′-1), 0-(y′-1)).

After the vertical blanking interval, the video portion of the frame 110, pixels 110(x′-x″, y′-y″) are scanned. The scanning of the video portion of the frame 110 causes the generation of an analog video signal. The analog video signal causes the display device 115 to display the video data, thereon.

The graphics engine 105 can be implemented in a variety of ways. For example, the graphics engine 105 can be implemented as a hardwired logic. Alternatively, the graphics engine 105 can be implemented as a set of instructions for execution by a processor. For example, the video encoder 100 can be implemented as an application specific integrated circuit (ASIC), with a processor embedded therein. The graphics engine 105 can be implemented as firmware programmed into memory and executed by the processor embedded into the ASIC.

The auxiliary data can comprise data in accordance with a common standard. For example, this information can include control data, such as an indicator identifying the video as part of a particular program. Alternatively, the auxiliary data can comprise data associated with a particular user features, such as close captioning. The Video Programming System (VPS) is a standard for providing control information and is incorporated herein by reference.

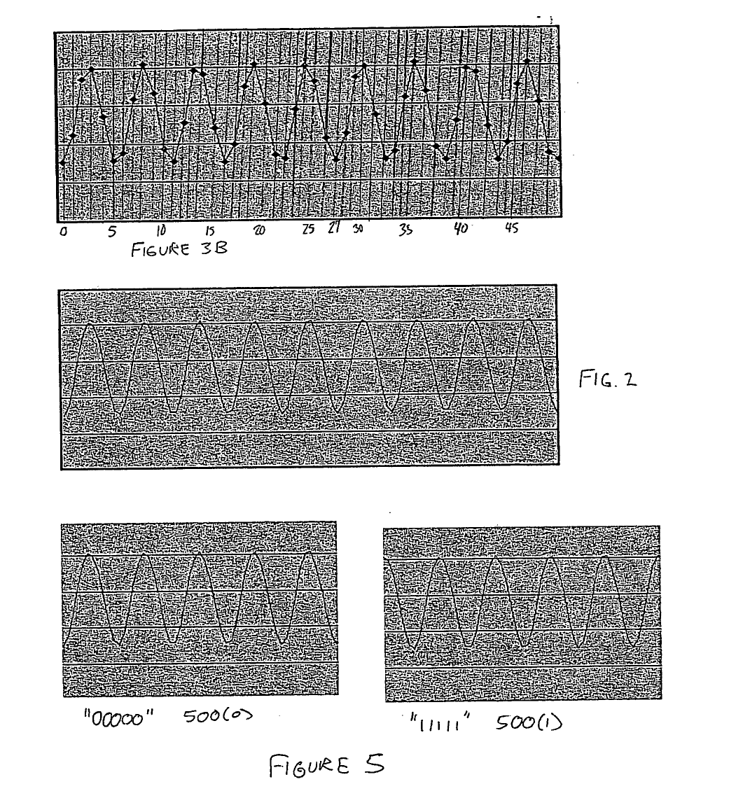

Referring now to FIG. 2, there is illustrated a block diagram describing an exemplary VPS signal. The VPS signal is generated using a bi-phase modulation with a data rate of 2.5 Mbits/sec. Each logical bit is represented by two complement signal elements. A logical ‘1’ is represented by two signal elements “0” and “1”. A logical ‘0’ is represented by two signal elements “1” and “0”. The signal shape of the VPS signal is an approximation of a cosine square with a pulse period of 200 ns. The analog signal associated with the pixels 110(0-(x′-1), 0-(y′-1)) carrying the auxiliary data can correspond to a particular VPS signal by appropriate selection of pixels values.

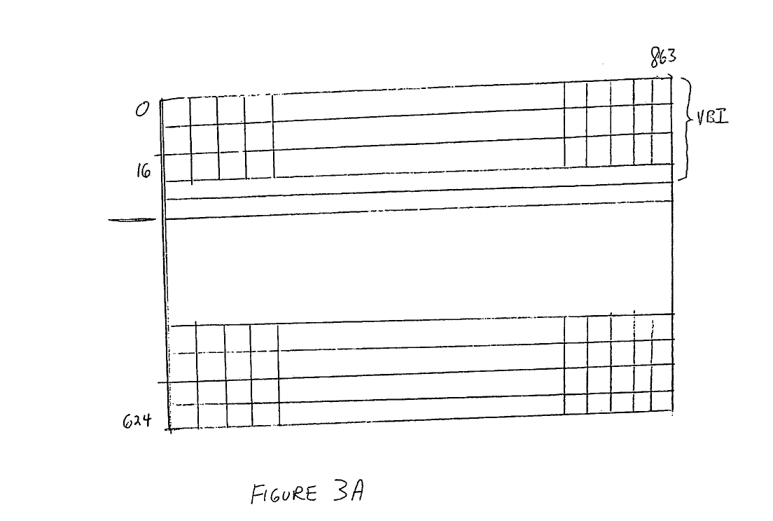

Referring now to FIG. 3A, there is illustrated a block diagram of an exemplary PAL 625 Lines System frame 310. The frame 310 comprises 625 lines of 864 pixels 310(0-624, 0-863). A portion of each frame 310, lines 310(23 1/2-310, 336-623 1/2) corresponds directly to the video portion of the frame. The portion of the frame 310, lines 110 (1-23 1/2, Y), (311-336, y), and (623 1/2-625, y) is scanned during the vertical blanking interval.

Pursuant to VPS, line 16, pixels 310(16, y), corresponds to a VPS signal carrying 15 bytes or 120 bits of auxiliary data. The encoder 100 generates the VPS signal using a line of pixels 310(16,y). A series of different pixels are generated to approximate desired VPS signals. The video clock rate for the PAL 625 lines system is 13.5 MHz. Because there are 864 pixels per line, each pixel is approximately 74.07 ns apart. The sampling rate for each VPS element is 5 MHz. Approximately 2.7 pixels are scanned in the time period for one element. Therefore, each pixel is spaced by a ratio of 10/27 elements from the next pixel. Additionally, 27 pixels can represent 10 elements and 5 VPS bits. The 120 bits of auxiliary data can be represented by 648 pixels, e.g., pixels 310(16, 0-647).

Each pixel can be associated with a particular sample of a data signal transmitting the data. Based on the horizontal position of the pixel, the pixel can correspond to a sample of the data signal at a particular time. The pixel can be a function of the sample corresponding, thereto.

Referring now to FIG. 3B, there is illustrated a block diagram of the VPS signal samples and associated with pixels. Based on its horizontal position in the frame 310, each pixel can be associated with a polyphase coefficient. Because the VPS signal is generated using bi-phase modulation of a periodic signal, the polyphase coefficients represent a phase of the waveforms representing the elements, 0 and 1. The formula below relates the horizontal position of a pixel, y, with a polyphase coefficient.

Coefficient=(10*y mod 27)/27

For example, a pixel at position 310(16, 46) can be associated with the polyphase coefficient 1/27. Therefore, the pixel 310(16,46) can correspond to a sample at the 1/27th of the period of a waveform representing an element. For example, in the case of a cosine square, the phase of sample corresponding to a pixel is Coefficient*2 pi. The corresponding sample is the value of the waveform at the phase. In the case of the cosine square function, the value of a sample corresponding to a pixel is:

Sample=CosineSquare(Coefficient*½ pi)

The horizontal axis in FIG. 3B indicates the horizontal pixel values, while the plots indicate the samples corresponding to the pixels for the exemplary signal in FIG. 2. The pixel can be a function of a sample corresponding thereto. For example, the pixel can be related to the corresponding sample by the following equation:

Pixel=F(sample)=sample*mpv

where mpv=the maximum possible pixel value

An exemplary pixel assignment corresponding to the samples in FIG. 3B is shown in the table below.

| | |
|---|---|
| 0 | 0 |
| 1 | 52 |
| 2 | 157 |
| 3 | 175 |
| 4 | 85 |
| 5 | 2 |
| 6 | 17 |
| 7 | 119 |
| 8 | 182 |
| 9 | 129 |
| 10 | 24 |
| 11 | 0 |
| 12 | 73 |
| 13 | 170 |
| 14 | 164 |
| 15 | 62 |
| 16 | 0 |
| 17 | 32 |
| 18 | 139 |
| 19 | 181 |
| 20 | 108 |
| 21 | 11 |
| 22 | 6 |
| 23 | 96 |
| 24 | 179 |
| 25 | 149 |
| 26 | 42 |
| 27 | 0 |
| 28 | 52 |
| 29 | 157 |
| 30 | 175 |
| 31 | 85 |
| 32 | 2 |
| 33 | 17 |
| 34 | 119 |
| 35 | 182 |
| 36 | 129 |
| 37 | 24 |
| 38 | 0 |
| 39 | 73 |
| 40 | 170 |
| 41 | 164 |
| 42 | 62 |
| 43 | 0 |
| 44 | 32 |
| 45 | 139 |
| 46 | 181 |
| 47 | 108 |
| 48 | 11 |
| 49 | 0 |

Although the encoder 100 could calculate the pixel value for each pixel on a real time basis, it may be faster and less computationally intense to use a lookup table. As noted above, 27 samples represent 10 element or 5 data bits. Accordingly, the 27 samples can represent 32 different bit patterns, and 32 different data signals. Therefore, a lookup table can be generated that correlates the samples corresponding to 27 pixels for each of the bit patterns.

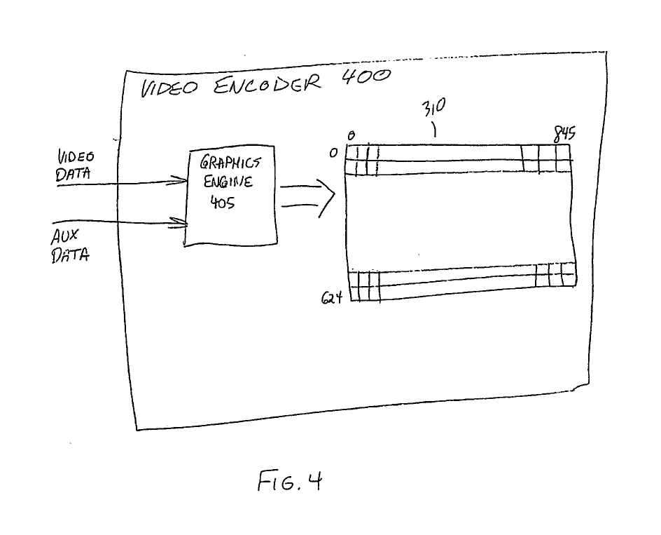

Referring now to FIG. 4, there is illustrated a block diagram describing an exemplary video encoder 400 in accordance with another embodiment of the present invention. The video encoder 400 comprises a graphics engine 405. The graphics engine 405 receives video data and auxiliary data, and outputs PAL 625 Lines System frames 310. The frames 310 comprise 625 lines of 846 pixel 310(x,y). A portion of each frame 310, pixels 310(23 1/2-310″,336-623) corresponds directly to the video data (now referred to as the video portion of the frame). Another portion of the frame 310, pixels 310 (0-(x′-1), 0-(y′-1)) is associated with the vertical blanking interval. The graphics engine 405 encodes line 16 of the frame 310, pixels 310(16, y) with values that are a function of samples corresponding to a signal representing the auxiliary data.

The video encoder 400 also includes a table 415. Table 415 comprises 32 entries 420(0) . . . 420(31). Each entry 420(0) . . . 420(31) is associated with a particular 5 bit pattern 425, e.g., “00000”, “00001”, etc. The entry includes 27 samples 430 from a VPS signal representing the associated bit pattern 425. The samples 430 can correspond to 27 consecutive pixels. The graphics engine 405 encodes the auxiliary data into the frame 310 by receiving 5 bits of the auxiliary data at a time. The graphics engine 405 then looks up the 5 bits in the table 415 and retrieves the 27 samples 430 in the entry 420 associated with the 5 bits. The 27 samples 430 correspond to 27 pixels, e.g., pixels 310(16, 0-26), and the graphics engine 405 codes the each of the corresponding 27 pixels as a function of the sample corresponding thereto. The graphics engine 405 repeats the foregoing with the next 5 bits of auxiliary data and the next 27 pixels, e.g., pixels 310(16, 27-53).

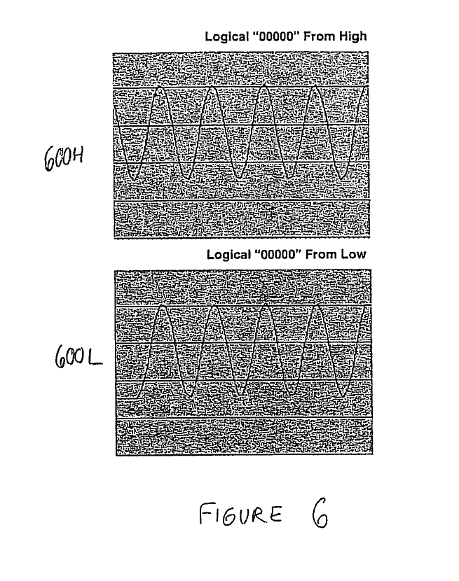

Referring now to FIG. 5, there is illustrated a block diagram describing a signal 500(0) for the bit pattern “00000” and the signal 500(1) for the bit pattern “11111”. As can be seen, it is difficult to concatenate the two signals above to produce a new signal “00000_{—}11111” in a manner that maintains continuity. The voltage swing between signal 500(0) and 500(1) is too abrupt and will cause most decoders to misinterpret the signal.

The foregoing can be alleviated by the use of two waveforms for each bit pattern, wherein one waveform for each bit pattern represents the bit pattern when transitioning from a low voltage level, and wherein the other waveform represents the bit pattern when transitioning from a high voltage.

Referring now to FIG. 6, there are illustrated exemplary signals 600H, and 600L for the bit pattern “00000”. The signal 600H is an easier signal to concatenate to another signal ending in a high voltage state, such as for example, signal 500(1). The signal 600L is an easier signal to concatenate to another signal ending in a low voltage state, such as for example, signal 500(0).

Referring now to FIG. 7, there are illustrated exemplary signals 700H, and 700L for the bit pattern “00000”. The signal 700H is an easier signal to concatenate to another signal ending in a high voltage state, such as for example, signal 500(1). The signal 600L is an easier signal to concatenate to another signal ending in a low voltage state, such as for example, signal 500(0).

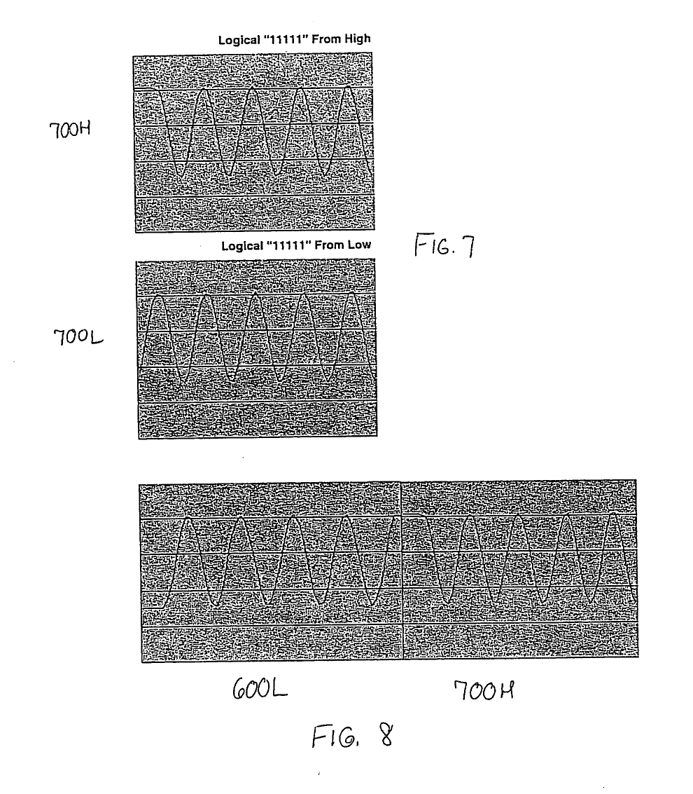

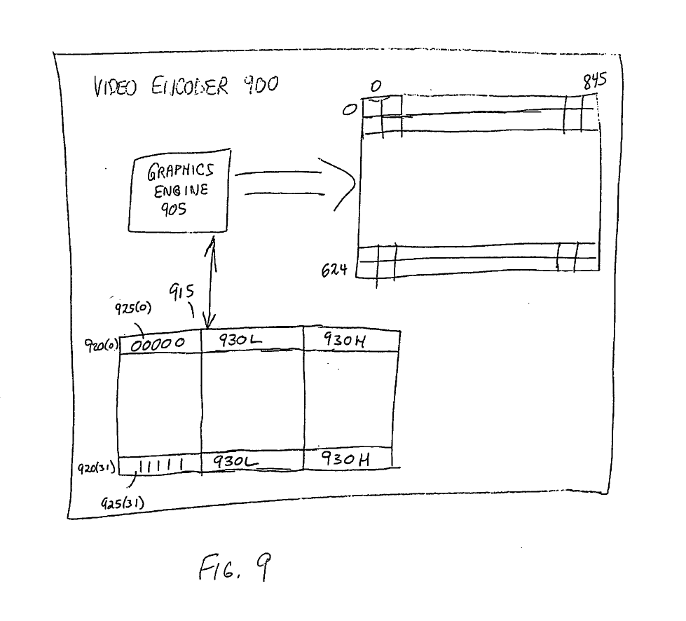

Referring now to FIG. 8, there is illustrated a block diagram describing the concatenation of two signals 500L and 700H, representing the data bit stream “00000” followed by “11111”. The signal 500L representing “00000” ends with a high voltage. Although “11111” is represented by both signals 700H and 700L, the graphics engine 505 selects signal 700H.

Accordingly, two signals can be sampled for each set of 5 bits. The samples for each signal can be stored in a table. The graphics engine 505 can select the samples based on the 5 auxiliary data bits to encode as well as the voltage state of the signal representing the previous 5 bits.

In an exemplary case, if the pixels 310(16, 0-26) are encoded with samples for a signal representing “00000”. The signal representing “00000” ends in high voltage state. Accordingly, the signal for representing the next 5 auxiliary bits is the signal for transitioning from a high-level voltage state. For example, if the next 5 auxiliary bits were “11111”, the samples for signal 700H are selected, and pixels 310(16, 27-53) are encoded with a value that is a function of the samples for signal 700H.

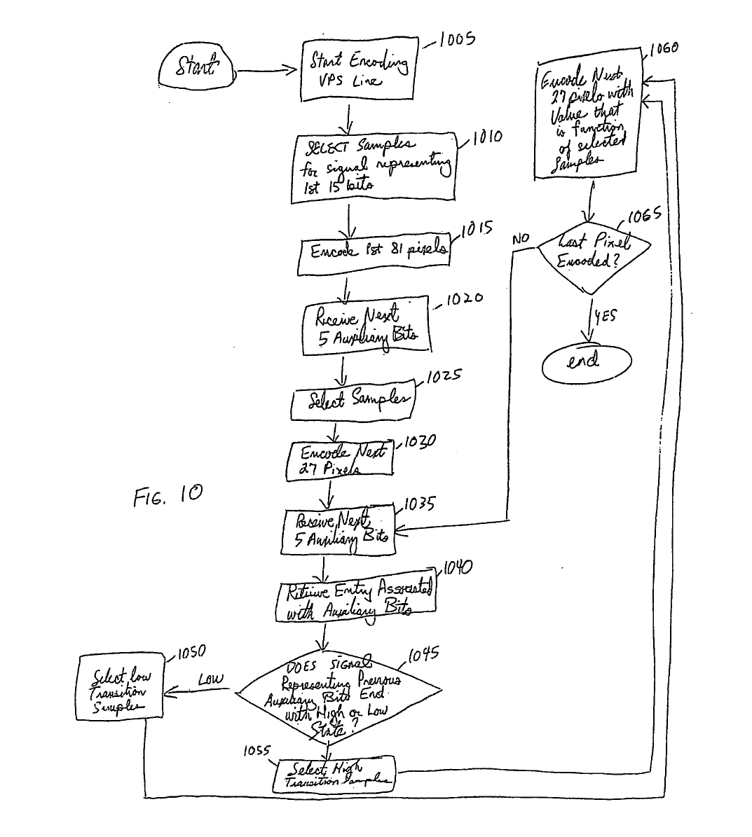

Referring now to FIG. 9, there is illustrated a block diagram describing an exemplary video encoder 900 in accordance with another embodiment of the present invention. The video encoder 900 comprises a graphics engine 905. The graphics engine 905 receives video data and auxiliary data, and outputs PAL 625 Lines System frames 310. The frames 310 comprise 625 lines of 846 pixel 310(x, y). A portion of each frame 310, pixels 310(x′-x″, y′-y″), corresponds directly to the video data (now referred to as the video portion of the frame). Another portion of the frame 310, pixels 310 (0-(x′-1), 0-(y′-1)) is associated with the vertical blanking interval. The graphics engine 905 encodes line 16 of the frame 310, pixels 310(16, y) with values that are a function of samples corresponding to a signal representing the auxiliary data.

The video encoder 900 also includes a table 915. Table 915 comprises 32 entries 920(0) . . . 920(31). Each entry 920(0) . . . 920(31) is associated with a particular 5 bit pattern 925, e.g., “00000”, “00001”, etc. The entry includes two sets of 27 samples 930L, 930H from VPS signals representing the associated bit pattern 925 transitioning from a low-level voltage state 930L, and transitioning from a high-level voltage state 930H.

The samples 930L, 930H correspond to 27 consecutive pixels. The graphics engine 905 encodes the auxiliary data into the frame 310 by receiving 5 bits of the auxiliary data at a time. The graphics engine 905 then looks up the 5 bits in the table 915 and retrieves the particular 27 samples 930L or 930H in the entry 920 associated with the 5 bits, based on whether the signal representing the previous 5 bits of the auxiliary data ends in a high-level voltage state or a low-level voltage state. The selected 27 samples 930L or 930H correspond to 27 pixels, e.g., pixels 310(16, y), and the graphics engine 905 codes the each of the corresponding 27 pixels as a function of the sample corresponding thereto. The graphics engine 905 repeats the foregoing with the next 5 bits of auxiliary data and the next 27 pixels, e.g., pixels 310(16, y+27).

It is noted that the number of lookups can be reduced, in certain cases. For example, the first 15 bits of a VPS signal, represented by pixels 310(16, 0-80), represent the clock run-in and start code and are fixed. Accordingly the 81 samples for a signal representing the first 15 bits of the VPS signal can also be stored. At the beginning of the VPS signal, the graphics engine 905 can automatically disregard the first 15 bits of the auxiliary signal and encode pixels 310(16, 0-80) with the samples for the signal representing the first 15 bits, without performing a table 915 lookup.

Referring now to FIG. 10, there is illustrate a block diagram describing the operation of the video encoder in accordance with an embodiment of the present invention. At 1005, the graphic engine 405 starts encoding a VPS line, e.g., starting from pixels (16, 0). At 1010, the graphics engine 905 selects the 81 samples for a signal representing the first 15 bits of the VPS signal. At 1015, the graphics engine 905 encodes the pixels (16, 0-80) with the 81 samples for the signal representing the first 15 bits of the VPS signal.

At 1020, the graphics engine 905 receives the next 5 bits of auxiliary data. At 1025, the graphics engine 905 retrieves the entry 920 associated with the 5 bits of auxiliary data received during 1020. Because the signal representing the first 15 bits ends with a Low-level voltage state, the graphics engine 905 selects (at 1025) the samples 930H. At 1030, the graphics engine 905 encodes the pixels 310(16, 81-107) with the with the samples selected during 1025.

At 1035, the graphics engine 905 receives the next 5 auxiliary data bits. At 1040, the graphics engine 905 retrieves the entry 920 associated with the 5 auxiliary data bits received during 1035. At 1045, the graphics engine 905 determines whether the signal representing the previous 5 auxiliary bits ends with a high-level voltage state or a low-level voltage state.

The foregoing determination can be made by examining the last bit of the previous 5 auxiliary data bits. If the last bit of the previous 5 auxiliary data bits is a “1”, then the signal representing the last five auxiliary data bits ends with a low-level voltage state. If the last bit of the previous 5 auxiliary data bits is a “0”, then the signal representing the last five auxiliary data bits ends with a high-level voltage state.

If during 1045, the graphics engine 905 determines that the signal representing the previous 5 auxiliary bits end with a low-level voltage state, then the samples 925L corresponding to transitioning from a low-level voltage state in the entry 920 are selected (at 1050). If during 1045, the graphics engine 905 determines that the signal representing the previous 5 auxiliary bits end with a high-level voltage state, then the samples 925H corresponding to transitioning from a high-level voltage state in the entry 920 are selected (at 1055). At 1060, the next 27 pixels are encoded with a value that is a function of the 27 samples selected during either 1050 or 1055.

At 1065, a determination is made whether the pixels encoded during 1060 include pixel (16, 647), the last pixel encoding the 120 bits associated with a VPS signal. If not, then 1035-1065 are repeated. If so, then the process is completed.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment(s) disclosed, but that the invention will include all embodiments falling within the scope of the appended claims.

1. A method for transmitting data, said method comprising:
determining one or more samples for a signal, the signal representing the data; and
generating a frame comprising at least one pixel that is a function of particular ones of the one or more samples.

2. The method of claim 1, wherein the at least one pixel is in a vertical blanking interval.

3. The method of claim 1, wherein determining the one or more samples further comprises:
selecting a plurality of samples corresponding to a plurality of bits of the data.

4. The method of claim 3, wherein selection of a plurality of samples corresponding to the plurality of bits of the data is dependent on another bit of the data.

5. A video encoder for transmitting data, said video encoder comprising a graphics engine for determining one or more samples for a signal, the signal representing the data and generating a frame comprising at least one pixel that is a function of particular ones of the one or more samples.

6. The video encoder of claim 5, wherein the at least one pixel is in a vertical blanking interval.

7. The video encoder of claim 5, further comprising:
a table for storing a plurality of entries, wherein each entry is associated with a particular one of a plurality of bit patterns, each entry comprising samples for a signal representing the particular one of the plurality of bit patterns associated with the entry;
the graphics engine selecting the samples in a particular one of the entries associated with a plurality of bits of the data.

8. The video encoder of claim 7, wherein the entry comprises two set of samples, and wherein the graphics engine selects one of the two sets of samples in the particular entry based on other bits of the data that preceed the plurality of bits of the data.

9. The video encoder of claim 5, wherein the signal comprises a Video Programming System Signal.

10. An integrated circuit for transmitting data, said integrated circuit comprising:
a processor for executing a plurality of instructions;
memory for storing a plurality of executable instructions, wherein execution of the plurality of executable instructions by the processor causes:
determining one or more samples for a signal, the signal representing the data; and
generating a frame comprising at least one pixel that is a function of particular ones of the one or more samples.

11. The integrated circuit of claim 10, wherein the at least one pixel is in a vertical blanking interval.

12. The integrated circuit of claim 10, wherein determining the one or more samples further comprises:
selecting a plurality of samples corresponding to a plurality of bits of the data.

13. The integrated circuit of claim 12, wherein selection of a plurality of samples corresponding to the plurality of bits of the data is dependent on another bit of the data.
